(19) United States
(12) Patent Application Publication
(10) Pub. No.: US 2018/0113799 A1
(43) Pub. Date: Apr. 26, 2018

(54) MODEL GENERATION FOR MODEL-BASED APPLICATION TESTING

(71) Applicant: CA, Inc., Islandia, NY (US)

(72) Inventors: Udai Shankar M.V., Hyderabad (IN); Krishna Chaithanya Kasibhatla, Hyderabad (IN); Dipti Shiralkar, Hyderabad (IN); Venugopal Chinnakotla, Kadapa (IN)

(21) Appl. No.: 15/332,840

(22) Filed: Oct. 24, 2016

(51) Int. Cl. G06F 11/36

(52) U.S. Cl. CPC G06F 11/3688; G06F 11/3664; G06F 11/3684

(57) ABSTRACT

In one embodiment, control-flow information comprising an indication of function execution order for an application may be generated using source code for the application. Function information for the application may be identified, the function information comprising an indication of an execution context for a function of the application. A model graph to test the application may be generated based on the control-flow information and the function information.

### BACKGROUND

The present disclosure relates in general to the field of software development, and more specifically, to generating models for model-based software testing.

As software applications become increasingly sophisticated, their complexity also increases, along with the number and variety of underlying components and features. Developing complex software, such as an application and/or application programming interface (API), may be challenging, as its numerous components and features must each be developed, configured, tested, and maintained. Testing software, for example, may involve numerous complex tests, using many different test cases and use cases, of both the underlying components individually and the software as a whole. Creating the test cases for testing the software may itself be a complex and time-intensive undertaking.

### BRIEF SUMMARY

According to one aspect of the present disclosure, control-flow information comprising an indication of function execution order for an application may be generated using source code for the application. Function information for the application may be identified, the function information comprising an indication of an execution context for a function of the application. A model graph to test the application may be generated based on the control-flow information and the function information.

### BRIEF DESCRIPTION OF THE DRAWINGS

FIG. 1 illustrates a simplified schematic diagram of an example computing environment for software applications.

FIG. 2 illustrates a simplified block diagram of an example software development system.

FIGS. 3A, 3B, 3C, and 3D illustrate an example use case of model generation for model-based application testing.

FIG. 4A illustrates an example monolithic architecture for a software application.

FIG. 4B illustrates an example microservices architecture for a software application.

FIG. 5 illustrates an example software container environment.

FIG. 6 illustrates an example application modeling and development tool.

FIG. 7 illustrates a flowchart for an example embodiment of model generation for model-based application testing.

Like reference numbers and designations in the various drawings indicate like elements.

### DETAILED DESCRIPTION

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

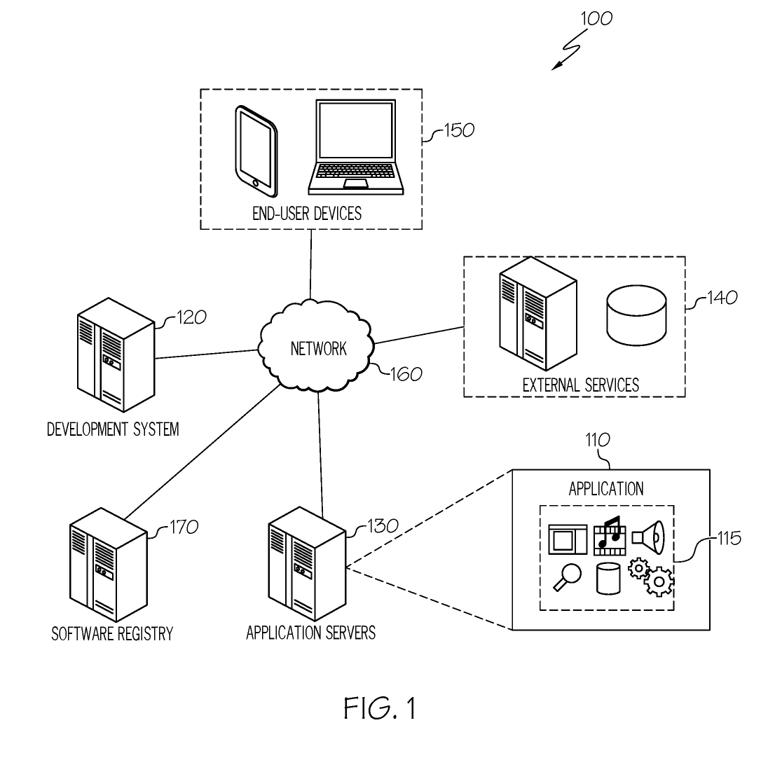

FIG. 1 illustrates a simplified schematic diagram of an example computing environment 100 for software applications. In some embodiments, computing environment 100 may include functionality for generating models used to test software, as described throughout this disclosure. The illustrated computing environment 100 includes software application 110, application servers 130, external services 140, software development system 120, and software registry 170, among other hardware and software computing elements. In some implementations, functionality of the various illustrated components, and other associated systems and tools, may be combined or even further divided and implemented among multiple different systems.

Application 110 may be any type of software that is developed and/or hosted in computing environment 100. For example, application 110 may be an application programming interface (API), software application, program, library, module, or portion of a larger, multi-tiered software system (collectively referred to herein as a software “component”). Application 110 may be developed using software development system 120. In addition, application 110 may be hosted or deployed on one or more application servers 130. Application 110 may be implemented using a monolithic architecture, a microservices architecture, or any other software design approach. A monolithic application may be implemented as a single application that integrates all associated components and functionality. A microservices application may be implemented using multiple separate and self-contained applications, or microservices 115, that each provide a particular service and collectively form a fully functional application. A microservices architecture may allow each underlying microservice 115 of an application 110 to be independently developed, deployed, updated, and scaled, resulting in numerous efficiencies in the software development process. In some cases, an application 110 may also be implemented using software containers (e.g., Docker containers, Open Container Initiative (OCI) based containers, and/or any other software container implementation). Analogous to shipping containers, software containers may package a particular software component with all of its dependencies to ensure that it runs the same in any environment or infrastructure, out-of-the-box. For example, a software container may package everything required to run a particular software component, such as the code, software libraries, configuration, files, runtime environment, and any other associated tools or applications. Software containers may also share a host operating system, thus avoiding the inefficiencies of virtual machines which each require their own guest operating system on top of the host operating system. Microservices applications may be implemented using software containers, for example, by packaging each microservice 115 of an application 110 into separate software containers.

Application servers 130 may host software developed using software development system 120, such as software applications and APIs 110. Application servers 130 may provide a server environment for running the application 110 and interfacing with its end-users 150. For example, application servers 130 may host web applications for websites, mobile back-ends for mobile applications, databases, and service-based applications (e.g., applications that provide services to other applications), among other examples. Applications 110 hosted on application servers 130 may utilize, consume data and services of, provide data or services to, or otherwise be at least partially dependent on, or function in association with, one or more other software components or applications hosted on the same server system (e.g., application server 130) or a different server system (e.g., external services 140). Applications 110 may be hosted on systems of a single entity or may be distributed among systems controlled by one or more third parties, among other examples.

External services 140 may be third party services used by application 110. For example, external services 140 may be implemented by software components and/or databases hosted by a third party to provide a particular service, such as cloud services, audio and video streaming, messaging, social networking, mapping and navigation, user authentication, payment processing, news, and weather, among other examples. In some embodiments, external services 140 may be hosted by third parties using application servers and/or database servers.

Software development system 120 may facilitate development, configuration, testing, deployment, and/or maintenance of software, such as software applications and APIs 110. For example, development system 120 may include tools and functionality for use in the software development cycle, including integrated development environments (IDE), application modeling, configuration, version control, compiling, testing, debugging, deployment, and maintenance, among other examples. Systems and services that facilitate software development (e.g., development system 120 and software registry 170) may be provided local to, or remote from (e.g., over network 160), the end-user devices 150 of software developers, and/or the target systems used to host the software (e.g., application servers 130 and external services 140).

Software registry 170 may host a repository of software packages that can be used by or used with a particular software application 110, including application programming interfaces (APIs), software libraries or environments, other software applications or components (e.g., database servers, web servers), and operating systems, among other examples. For example, in some cases, application 110 may rely on a variety of existing software packages, and during development of application 110, development system 120 may obtain the appropriate software packages for building application 110 from software registry 170. Throughout the life of the application 110, development system 120 may also obtain any new versions, releases, updates, patches, bug fixes, or other revisions to those associated software packages. Software packages hosted by software registry 170 may be stored, in some embodiments, using software images corresponding to particular software packages. For example, software packages that are implemented using software containers may be stored in software registry 170 using container images, which may include all components and dependencies required to run a particular software package in a software container. A container image may be a file format used to package the components and dependencies of a containerized software package, such as Docker container images, Open Container Initiative (OCI) based images, and/or any other container image format.

End-user devices 150 may include any type of device that allows a user to interact with the components of computing environment 100. For example, software developers may utilize end-user devices 150 to develop software (e.g., application 110) using software development system 120. As another example, users of a software application 110 may utilize end-user devices 150 to access the application. End-user devices 150 may interact with components of computing environment 100 either locally or remotely over a network 160. For example, in some embodiments, software developers may utilize end-user devices 150 that are local to or integrated with the development system 120, while in other embodiments software developers may utilize end-user devices 150 that interact with the development system 120 over a network 160. End-user devices 150 may include, for example, desktop computers, laptops, tablets, mobile phones or other mobile devices, wearable devices (e.g., smart watches, smart glasses, headsets), smart appliances (e.g., televisions, audio systems, home automation systems, refrigerators, washer/dryer appliances, heat-ventilation-air-conditioning (HVAC) appliances), and the like.

One or more networks 160 may be used to communicatively couple the components of computing environment 100, including, for example, local area networks, wide area networks, public networks, the Internet, cellular networks, Wi-Fi networks, short-range networks (e.g., Bluetooth or ZigBee), and/or any other wired or wireless communication medium. For example, users of application 110 may access the application remotely over a network 160 on application servers 130 using end-user devices 150. As another example, application 110 may utilize external services 140 that are accessed remotely over a network 160. As another example, software developers may access development system 120 remotely over a network 160 using end-user devices 150. As another example, development system 120 may obtain software images remotely over a network 160 from software registry 170.

In general, elements of computing environment 100, such as “systems,” “servers,” “services,” “registries,” “devices,” “clients,” “networks,” and any components thereof (e.g., 120, 130, 140, 150, 160, and 170 of FIG. 1), may include electronic computing devices operable to receive, transmit, process, store, or manage data and information associated with computing environment 100. As used in this disclosure, the term “computer,” “processor,” “processor device,” or “processing device” is intended to encompass any suitable processing device. For example, elements shown as single devices within computing environment 100 may be implemented using a plurality of computing devices and processors, such as server pools comprising multiple server computers. Further, any, all, or some of the computing devices may be adapted to execute any operating system, including Linux, other UNIX variants, Microsoft Windows, Windows Server, Mac OS, Apple iOS, Google Android, etc., as well as virtual machines adapted to virtualize execution of a particular operating system, including customized and/or proprietary operating systems.

Further, elements of computing environment 100 (e.g., 120, 130, 140, 150, 160, and 170 of FIG. 1) may each include one or more processors, computer-readable memory, and one or more interfaces, among other features and hardware. Servers may include any suitable software component or module, or computing device(s) capable of hosting and/or serving software applications and services, including distributed, enterprise, or cloud-based software applications, data, and services. For instance, in some implementations, development system 120, application servers 130, external services 140, software registry 170, and/or any other sub-system or component of computing environment 100, may be at least partially (or wholly) cloud-implemented, web-based, or distributed for remotely hosting, serving, or otherwise managing data, software services, and applications that interface, coordinate with, depend on, or are used by other components of computing environment 100. In some instances, elements of computing environment 100 (e.g., 120, 130, 140, 150, 160, and 170 of FIG. 1) may be implemented as some combination of components hosted on a common computing system, server, server pool, or cloud computing environment, and that share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Software applications 110, such as those developed and deployed in example computing environment 100, are becoming increasingly sophisticated. As software applications 110 become more sophisticated, their complexity also increases, along with the number and variety of underlying components and functionality 115. Many modern software applications 110, for example, may be composed of a variety of underlying components 115. An application programming interface (API), for example, may include various different functions or services 115. A microservices application 110, for example, may include many different microservices 115. Similarly, applications 110 implemented using software containers may include many different software containers and associated container images. A containerized microservices application 110, for example, may include numerous microservice containers (e.g., software containers for each microservice 115) and associated container images (e.g., container images for each microservice 115 container).

Developing a complex software application 110 may be challenging, as its numerous components and features 115 must each be developed, configured, tested, and maintained or updated. Development of an application 110, for example, may involve multiple separate development teams and/or entities that are each responsible for developing different components 115. Moreover, because the various components 115 of the application 110 may be developed by different development teams and/or entities, new versions of each underlying component 115 may be developed independently, and thus the timing and frequency of new version releases may vary for each underlying component 115 of the application 110. Accordingly, ensuring that the components of an application 110 are updated with the latest compatible versions may be challenging. Configuring a complex software application 110 may also be challenging, particularly as the number of underlying components 115 increases, as it may involve tailored configurations of each component of the application.

Testing a complex software application 110 may also be challenging, as it may involve numerous complex tests, using many different test cases and use cases, of both the underlying components 115 individually and the application 110 as a whole. Creating the test cases for testing an application 110 may itself be a complex and time-intensive undertaking. In some embodiments, model-based testing may be used to facilitate testing of applications and APIs 110. For example, in some embodiments, development system 120 may include model-based testing functionality. Model-based testing, for example, may involve creating a test model that represents the desired behavior, testing environments, and testing strategies for a system-under-test (e.g., an API or software application). The test model may then be used to automatically generate and perform various tests or test cases for the system-under-test. Existing solutions for model-based testing (e.g., Graph Walker, PyModel) must be supplied with a test model in order to perform the model-based testing. Thus, with existing solutions, a user or developer may be required to manually create the test model, which may be challenging and cumbersome for non-trivial software. For example, it may be challenging to create test models that adequately test all functionality and code, using all potential test cases, for an application 110.

In some embodiments, creation of the test models used to perform model-based testing may be facilitated and/or automated using model generation functionality. For example, in some embodiments, development system 120 may include model generation functionality. Model generation functionality may provide an approach to automating or facilitating the generation of test models used for model-based testing, which is a major step towards fully automatic test case generation and test automation. Model generation functionality, for example, may automatically generate test models, which may be fine-tuned using some user interaction. For example, there may be some minimal assistance from the user if the model cannot be fully derived from the source code and other available resources (e.g., existing test cases). For example, a test model for an application 110 may be generated by inspecting the source code, examining existing test cases, and/or obtaining additional testing related information from a user, if necessary. Model generation functionality may use concepts from graph theory, compilers, and machine learning, in order to automate the creation of test models and minimize the required user interaction or involvement, as described further throughout this disclosure.

This model generation and testing approach may be used for testing any type of software 110, including application programming interfaces (APIs), applications (e.g., monolithic or microservice applications), and user interfaces, among other software components. This model generation approach provides many benefits, including automated model generation for model-based application testing, which simplifies the model-based testing process for users and developers and minimizes their required involvement. This approach also leverages machine learning techniques to further reduce user involvement (e.g., by learning from existing test cases, from the user's testing related annotations, and so forth). In addition, testing of new versions, updates, bug fixes, and other changes to an application can be performed more efficiently, by reusing testing related information for the previous versions (e.g., existing test models, test cases, code flow analysis, and user annotations) to generate test models for the updated versions. This approach also encourages widespread use of model-based testing by eliminating a significant barrier of existing solutions that require users to manually create test models. In this manner, this model generation approach may significantly enhance the software development process, as it facilitates automated software testing, results in more robust software, saves time, and reduces the overall burden of testing complex software 110.

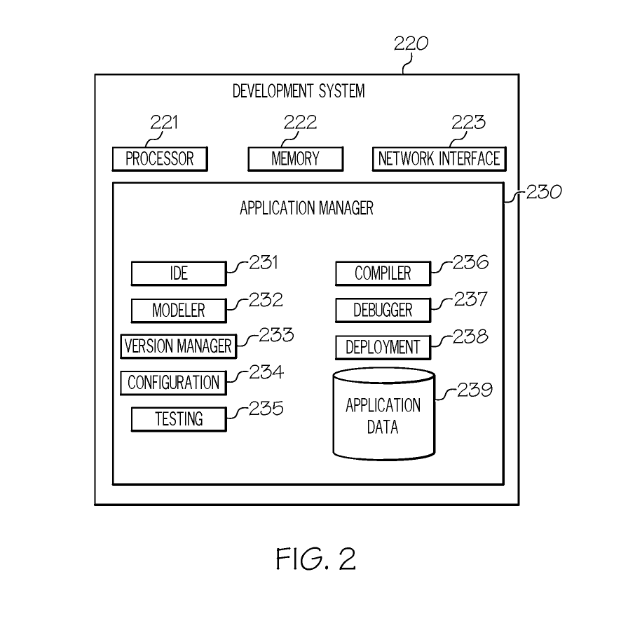

FIG. 2 illustrates a simplified block diagram of an example software development system 220. In some embodiments, software development system 220 may include functionality for generating models used to test applications and APIs, as described throughout this disclosure.

Software development system 220 may facilitate development, testing, deployment, and/or maintenance of software, such as application programming interfaces (APIs), software applications, programs, libraries, modules, or other software components (e.g., components of larger, multi-tiered software systems). In some embodiments, for example, software development system 220 may be used to implement the functionality of software development system 120 of FIG. 1. In certain embodiments, software development system 220 may include one or more processors 221, memory elements 222, and network interfaces 223, along with application development software, such as application manager 230. In some implementations, the various illustrated components of development system 220, and other associated systems and tools, may be combined, or even further divided and distributed among multiple different systems. For example, in some implementations, development system 220 may be implemented as multiple different systems with varying combinations of the foregoing components (e.g., 221, 222, 223, 230). Components of development system 220 may communicate, interoperate, and otherwise interact with external systems and components (including with each other in distributed embodiments) over one or more networks using network interface 223.

Application manager 230 may include a collection of components, functionality, and/or tools for facilitating development of software APIs and applications (e.g., application 110 of FIG. 1). For example, in some embodiments, application manager 230 may include integrated development environment (IDE) 231, application modeler 232, version manager 233, configuration module 234, testing module 235, compiler 236, debugger 237, deployment module 238, and/or application data storage 239, among other potential components, functionality, and tools (along with any combination or further division, distribution, or compartmentalization of the foregoing). In some embodiments, application manager 230, and/or its underlying components, may be implemented using machine executable logic embodied in hardware- and/or software-based components.

In some embodiments, an integrated development environment (IDE) 231 may be included to provide a comprehensive development environment for software developers. IDE 231, for example, may be a software development application with a user interface that integrates access to a collection of software development tools and functionality. For example, IDE 231 may integrate functionality for source code editing, intelligent code completion, application modeling, graphical user interface (GUI) building, version management and control, configuration, compiling, debugging, testing, and/or deployment. The boundary between an integrated development environment (e.g., IDE 231) and other components of the broader software development environment (e.g., software development system 220) may vary or overlap. In some embodiments, for example, IDE 231 may provide an interface that integrates the various components and tools of application manager 230, such as application modeler 232, version manager 233, configuration module 234, testing module 235, compiler 236, debugger 237, and/or deployment module 238.

In some embodiments, a compiler 236 may be provided to compile and/or build applications, for example, by compiling the source code of an application developed using development system 220. In some embodiments, a debugger 237 may also be provided to debug applications that are developed using development system 220.

In some embodiments, a deployment module 238 may also be provided to deploy applications that are developed using development system 220. For example, once an application has been developed, deployment module 238 may be used to deploy the application for live use by end-users. In some embodiments, for example, deployment module 238 may deploy the application on one or more live production servers, such as application servers 130 of FIG. 1.

In some embodiments, application data storage 239 may be used to store information associated with applications developed using development system 220, such as source code, configurations, version information, application models, and testing models, among other examples.

In some embodiments, a version manager 233 may be provided to facilitate version control and management for software applications. For example, version manager 233 may include a version control system. Version control systems, for example, may be used by software developers to manage changes to software, simultaneously work on different aspects and/or versions of the software, and recover previous versions of the software when needed. For example, version control systems may record the changes to files over time, allowing developers to revert files back to a previous state, revert an entire project back to a previous state, compare changes over time, identify authors and dates for particular files and/or revisions, and so forth. Version manager 233 may also be used to manage updates to the various packages used by software applications. For example, a software application may rely on a variety of existing software packages or components, including software libraries or environments, application programming interfaces (APIs), other software applications or components (e.g., database servers, web servers), and operating systems, among other examples. During development of a software application, development system 220 may obtain the appropriate software packages for building the application, for example, from a software registry (e.g., software registry 170 of FIG. 1). Throughout the life of the application, new versions of the underlying software packages used by the application may be released (e.g., new versions, releases, updates, patches, bug fixes, or any other revisions). Version manger 233 may facilitate updating the software application, when appropriate, with new versions of its underlying software packages.

In some embodiments, a configuration module 234 may be provided to configure applications that have been developed, or are being developed, using software development system 220. For example, configuration module 234 may be used to configure underlying software components, APIs, software containers (e.g., Docker containers, Open Container Initiative (OCI) based containers, and/or any other software container implementation), microservices, microservice containers, software images, databases, web servers, external services, network connections, filesystems, runtime environments, and deployment environments of an application, among other examples.

In some embodiments, an application modeler 232 may be provided to model the architecture of a software application. Software applications may be composed of, include, and/or rely on a variety of underlying software components. For example, applications may be implemented using a variety of software design approaches (e.g., monolithic or microservices architectures), and with a variety of APIs, software modules, components, containers, services, microservices (e.g., microservices 115 of FIG. 1), and/or external services (e.g., external services 140 of FIG. 1), among other examples. Microservices applications, for example, may be implemented by packaging a variety of microservices into separate software containers. Application modeler 232 may be used to design, configure, and/or update the architecture of a software application and its underlying components. For example, application modeler 232 may be used to design or configure an application by identifying each underlying component, along with its functionality and responsibilities, configuration, version, and relationship to other components, among other information. This configuration information for the application may be stored by the application modeler 232, for example, using application data storage 239. Application modeler 232 may also display a graphical representation of the application's design or architecture. For example, application modeler 232 may display graphical representations of each underlying software component of the application (including, for example, the name, version, and/or configuration of each component), the relationships between the underlying components, and so forth. In addition, in some embodiments, application modeler 232 may also provide or facilitate application testing, for example, as described in connection with testing module 235 (e.g., model generation and model-based testing).

In some embodiments, a testing module 235, or application testing agent, may be provided to test software applications that are developed using development system 220. Testing an application may involve numerous complex tests, using many different test cases and use cases, of both the underlying components individually and the application as a whole. Creating the test cases for testing an application may itself be a complex and time-intensive undertaking. In some embodiments, testing module 235 may include model-based testing functionality to facilitate application testing. Model-based testing may involve creating a test model that represents the desired behavior, testing environments, and testing strategies for a system-under-test (e.g., a software application). The test model may then be used to automatically generate and perform various tests for the system-under-test.

In some embodiments, testing module 235 may also include model generation functionality in order to automate or facilitate the process of creating test models used for model-based testing. For example, testing module 235 may generate test models for model-based testing by inspecting and parsing the source code of an application, analyzing and learning from existing testing related information, and/or obtaining any remaining testing related information from a user, as appropriate. The model generation functionality of testing module 235 uses concepts from graph theory, compilers, and machine learning in order to minimize the required user interaction or involvement. For example, the source code of an application may be parsed using graph theory, compiler, and program slicing techniques to identify code flows and atomicity of variables, which may be used to generate an initial or partial model. The partial model, for example, may identify the approximate function execution order with annotated information for each function. The partial model may be refined using annotations provided by a user or developer, if appropriate. Machine learning techniques may also be used to refine the partial model (e.g., by learning from the user annotations or other available information).

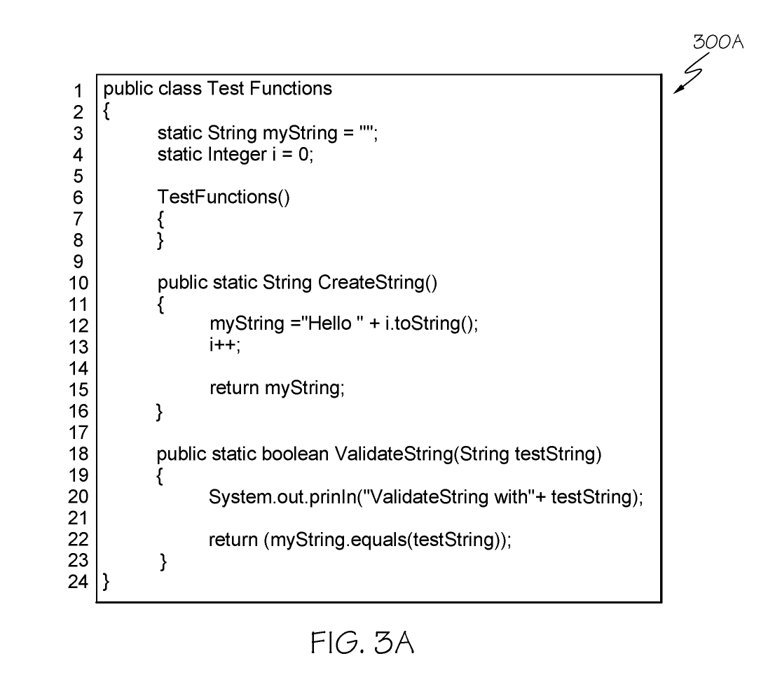

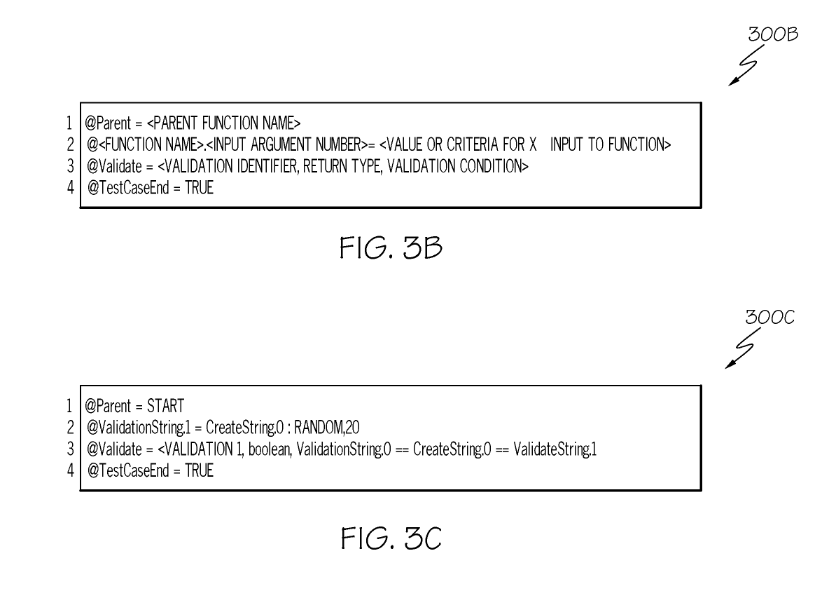

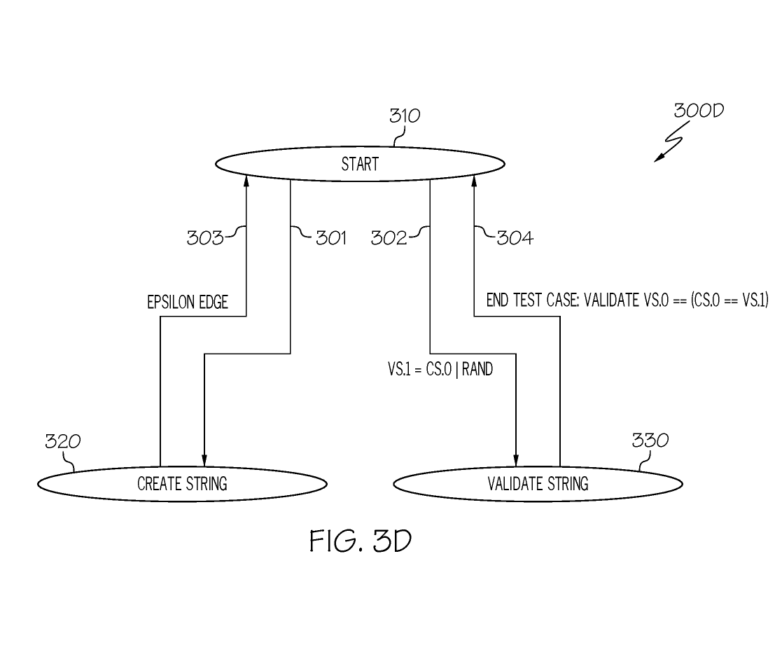

Model generation may begin by obtaining source code and/or other associated files and information for an API or application. For example, for a Java-based API, the Java archive file (JAR) and the source code of the API may be obtained. The JAR file may be used to extract all the classes and functions of the API. The source code may be parsed using program splicing techniques to identify the code flow, identify the atomicity of the variables, and derive an approximate order of function execution. This may facilitate an understanding of the call flow for the application, including the starting points and control flows for the application's data. Based on the JAR and source code analysis, a partial model for the application may be generated. The partial model, for example, may be a file identifying each function call and providing certain “annotations” or “comments” specifying additional information about each function (e.g., the annotations of FIGS. 3B and 3C), as explained further throughout this disclosure.

Program slicing, for example, may involve identifying a set of program statements (called a program slice) that may affect certain data at certain points of execution (e.g., the slicing criterion). Program slicing is used, for example, for software debugging (e.g., to identify the source of errors), program analysis, and/or optimization. For example, program slicing techniques may be based on those introduced by Mark Weiser and described in the following publications, which are incorporated by reference herein: M. Weiser, “Program slicing,” Proceedings of the 5^{th} International Conference on Software Engineering, pp. 439-449, IEEE Computer Society Press, March 1981; and M. Weiser, “Program slicing,” IEEE Transactions on Software Engineering, Volume 10, Issue 4, pp. 352-357, IEEE Computer Society Press, July 1984. These well-known program slicing techniques may be used to facilitate model generation, as described throughout this disclosure.

Machine learning techniques may also be used to further refine the partial model, for example, by analyzing existing testing related information (e.g., for the current or previous versions of the application, or for other applications). The partial model may be further refined, for example, by analyzing existing or previously provided test cases, test models, code flow analysis, and/or user annotations. For example, if example test cases for the application are provided by the user, the example test cases may be analyzed to learn or derive additional information about the atomicity and function precedence for the application. Similarly, user-supplied annotations to the partial model (described below) may also be analyzed to learn or derive additional information and annotations for the partial model.

The resulting partial model may include the derived code flow and function precedence, along with annotations specifying additional information for each function. For example, in a model graph, each function may be represented by a node in the graph, using an assumption that the behavior of each node is only affected by its parent node(s) (similar to a Markovian assumption or property). Thus, in the partial model, the annotations for each function may specify its parent function(s) and criteria for generating its inputs or arguments.

The partial model identifying the code flow and associated information may then be provided to the user. For example, the partial model may be provided in a file and/or displayed using a user interface. The user may then modify and/or add to the annotations in the partial model. For example, the user may modify the automatically generated annotations that specify the parent function(s) and input criteria for each function. In addition, if annotations for any functions were not derived automatically, the user may supply annotations for those functions. In addition, the user may add annotations to specify the validation criteria for each function. The validation criteria, for example, may be criteria or conditions used to validate the output of the function.

In some embodiments, the annotations in the partial model may be specified using a metalanguage, as explained further in connection with FIGS. 3A-3D. In addition, in some embodiments, the user may be able to provide these annotations directly in the source code of an application, for example, during development of the application.

At this point, the fully annotated partial model of the application may contain sufficient information for creating a model graph for the application. For example, the partial model may identify the classes and functions of an API or application, along with the function control flow, parent functions, function input criteria, and function validation criteria. Accordingly, a model graph for the application may then be generated using the partial model. The model graph may then enable model-based testing of the application, which may involve automated testing of the application using test cases generated based on the model graph. For example, the model graph may be used to generate inputs to the functions (e.g., based on the function input criteria), execute the functions using the generated inputs and according to the identified control flow, and determine whether the output of each function is valid (e.g., using the output validation criteria).

In this manner, the creation of test models used for model-based testing may be fully or partially automated, minimizing the user involvement required in the testing process. The model generation and testing functionality described in connection with FIG. 2 may be used to facilitate software development and testing for any type of software, including APIs, applications, user interfaces, and other software components, as described throughout this disclosure.

FIGS. 3A, 3B, 3C, and 3D illustrate an example use case of model generation for model-based software testing. FIG. 3A illustrates example software 300A to be tested using model-based testing. FIGS. 3B and 3C illustrate example annotations used for generating a model of the example software. FIG. 3D illustrates an example model graph 300D generated for model-based testing of the software 300A.

The example software 300A of FIG. 3A is a simple Java class named TestFunctions. The TestFunctions class includes two static variables: myString (type String) and i (type Integer). The myString variable is initialized as an empty string, and variable i is initialized to 0. The TestFunctions class also includes two functions: CreateString and ValidateString. The CreateString function performs the following actions: (1) assigns the myString variable with a string created by appending “Hello” with the value of variable i; (2) increments the variable i; and (3) and returns the myString variable. Thus, each time the CreateString function is called, the myString variable will be assigned “Hello 0”, “Hello 1”, “Hello 2”, and so forth. The ValidateString function takes a variable named testString (type String) as input, compares the testString variable to the myString variable to determine if they contain the same string, and then returns the result of the comparison (either TRUE or FALSE).

The TestFunctions class of FIG. 3A may be tested by generating a model for performing model-based testing. For example, the code may be parsed (e.g., using program slicing) to identify the approximate execution order. In the TestFunctions class, there are only two functions (CreateString and ValidateString), both functions can be called directly, and neither function calls the other function. Thus, the start or entry into the TestFunctions class can be either the CreateString or ValidateString function.

Next, a partial graph may be represented or generated by using annotations to specify context information for each function, such as the execution order, parent functions, function input criteria, and function output validation criteria. The annotations may be generated automatically based on the code parsing analysis, along with machine learning techniques described throughout this disclosure. In addition, if needed, the annotations may be modified and/or supplied by a user or developer.

FIG. 3B illustrates the format of a metalanguage that can be used to specify the annotations 300B. The annotations for a function may be preceded by an “@” symbol to identify them as annotations. In addition, the input arguments of a function may be referenced as FunctionName.1, FunctionName.2, FunctionName.3, and so forth. The output of any function may be referenced as FunctionName.0.

For example, the parent of a function may be identified using the following annotation (e.g., line 1 of FIG. 3B):
@Parent=<PARENT FUNCTION NAME>

The input criteria for generating the input arguments of a function may be specified using the following annotation (e.g., line 2 of FIG. 3B):
@<FUNCTION NAME>.<INPUT ARGUMENT #>=<CRITERIA FOR X^{th} FUNCTION INPUT>

The validation criteria for validating the output of a function may be specified using the following annotation (e.g., line 3 of FIG. 3B):
@Validate=<VALIDATION IDENTIFIER, RETURN TYPE, VALIDATION CONDITION>

Finally, the end of a test case may be identified using the following annotation (line 4 of FIG. 3B):
@TestCaseEnd=TRUE

The input criteria for a function (e.g., line 2 of FIG. 3B) may be specified using atomic and primitive values, composite types, and/or outputs of other functions. For example, the input criteria may specify that a function input can be based on atomic and primitive types, such as integers and strings, allowing random values of those primitive data types to be generated and passed as input to the function. The input criteria may also specify that a function input can be a composite type. For example, in Java, specifying an input argument using a composite type may require calling the constructor of that composite type, which itself is a function call that may become an intermediate node in the model graph. The input criteria may also specify that a function input can be an output of another function. For example, the input to the ValidateString function may be the output of the CreateString function. These input criteria annotations may be derived from code parsing and machine learning, but they may also be provided by a user or developer.

The validation criteria for a function (e.g., line 3 of FIG. 3B) may include a name or identifier for the result of the validation, the return type, and a validation condition. The validation condition may indicate that the output of a function is a specific value (e.g., a value that may be provided in a configuration file), or that the output of the function is based on the output of other functions. In some embodiments, the validation criteria and/or the result of the validation may be stored during testing for further processing, because the validation of one function may depend on the validation of another. In addition, validation criteria may be supplied for functions regardless of whether the function corresponds to the end of a test case (e.g., as indicated by the @TestCaseEnd annotation). The validation criteria annotations may be derived from code parsing and machine learning (e.g., using existing test cases to learn validation criteria), but they may also be provided by a user or developer.

FIG. 3C illustrates example annotations 300C for the ValidateString function of the TestFunctions class from FIG. 3A. The parent annotation “@Parent=START” (e.g., line 1 of FIG. 3C) indicates that the ValidateString function is called directly and does not have a parent function, and thus it may be the starting or entry point of the code.

The input criteria for the ValidateString function (e.g., line 2 of FIG. 3C) is specified using the following annotation:
@ValidateString.1=CreateString.0: RANDOM,20

This input criteria indicates that the first (and only) input argument of the ValidateString function (ValidateString.1) can either be the output of the CreateString function (CreateString.0) or a random string of length 20 (RANDOM,20).

The validation criteria for the ValidateString function (e.g., line 3 of FIG. 3C) is specified using the following annotation:
@Validate=Validation1, boolean, ValidateString.0==CreateString.0==ValidateString.1

This validation criteria specifies that the result of the validation is named “Validation1” and is a boolean value. In addition, the validation condition specifies that the output of the ValidateString function (ValidateString.0) should be TRUE if the output of the CreateString function (CreateString.0) is the same as the input of the ValidateString function (ValidateString.1); otherwise, the output of the ValidateString function (ValidateString.0) should be FALSE.

The end of the test case for the ValidateString function is identified using the “@TestCaseEnd=TRUE” annotation (e.g., line 4 of FIG. 3C).

FIG. 3D illustrates a model graph 300D generated based on the code flow analysis and annotations. For example, based on the code parsing and program slicing, there are only two functions in the TestFunctions class (CreateString and ValidateString), both functions can be called directly, and neither function calls the other function. Thus, the start or entry into the TestFunctions class can be either the CreateString or ValidateString function. Accordingly, a model graph may be generated with a start node 310, a node for the CreateString function 320, and a node for the ValidateString function 330. The start node 310, for example, may represent the starting or entrypoint of the code flow. Since execution can start by calling either the CreateString or ValidateString function, the start node 310 may include edges (301, 302) to both the CreateString node 320 and ValidateString node 330. Since the ValidateString function has one function input argument, the edge 302 from the start node 310 to the ValidateString node 330 may include the input criteria for the ValidateString function. Since the CreateString function has no input arguments, the edge 301 from the start node 310 to the CreateString node 320 may not include input criteria. In addition, since the functions do not call each other nor any other functions in the TestFunctions class (as there are no other functions in the class), each function node (320, 330) may include an edge (303, 304) back to the start node 310 to represent a return to the starting state after execution. Since the annotations 300C for the ValidateString function include validation criteria for the function and identify it as an end test case, the edge 304 from the ValidateString node 330 to the start node 310 may include the validation criteria and mark it as the end of a test case. Since no validation annotations were provided for the CreateString function, the edge 303 from the CreateString node 320 to the start node 310 may be an epsilon edge, which may simply represent a return to the start node 310 without any action. Finally, since the CreateString and ValidateString functions do not call each other, there are no edges between those function nodes.

The model graph 300D may then enable model-based testing of the TestFunctions class, which may involve automated testing using test cases that are generated from the model graph. For example, the model graph 300D may be used to generate inputs to the functions (e.g., based on the function input criteria), execute the functions using the generated inputs and according to the identified control flow, and determine whether the output of each function is valid (e.g., using the output validation criteria).

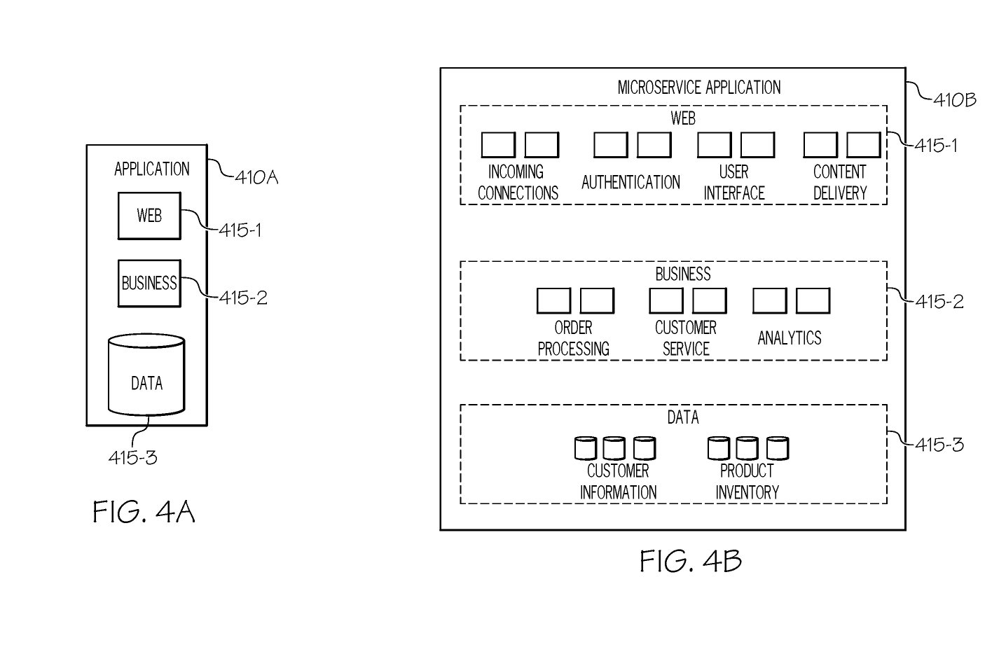

FIGS. 4A and 4B illustrate example monolithic and microservices architectures for a software application. The model generation and testing functionality described throughout this disclosure can be implemented for both microservices and monolithic applications, and/or for application programming interfaces (APIs) used by those applications.

Monolithic-based architectures and microservice-based architectures, for example, are software design approaches that may be used to implement an application. FIG. 4A illustrates an example monolithic architecture for a software application, and FIG. 4B illustrates an example microservices architecture for the same software application. A monolithic application, for example, may be implemented as a single application that integrates all associated components and functionality. While a monolithic application may have a logically modular architecture, it is packaged and deployed as one large application. For example, in FIG. 4A, monolithic application 410A is a single application with multiple logical components 415, including web logic 415-1, business logic 415-2, and data storage logic 415-3. Monolithic applications are common, and may be straightforward to develop since many development tools (e.g., IDEs) focus on building single applications. Monolithic applications may also be relatively straightforward to deploy—the complete application package, for example, may be copied to an application server and launched.

Monolithic approaches may work well in the early stages of an application and for smaller applications. Many applications, however, grow over time and eventually become highly complex. Accordingly, monolithic applications may be inefficient to develop and maintain, as they are often too complex for any single developer to fully understand, making simple tasks such as bug fixes and feature updates very difficult. In addition, any updates to the application, even if minor, often require the entire application to be tested and redeployed. Monolithic applications also make it difficult to adopt new programming languages, frameworks, or other new software technologies. Rewriting a large, complex application (e.g., with millions of lines of code) using a new technology is often impractical, leaving developers stuck with the original technologies that were chosen at the outset. Monolithic applications can also be unreliable. Because all functionality is running within the same process, any minor bug (e.g., memory leak) or hardware failure can be fatal to the entire application. Continuous deployment may also be challenging for monolithic applications. Continuous deployment is a software development trend to continuously push new changes into production rather than sporadically release new functionality, which can be very difficult for monolithic applications since the entire application must be redeployed when any aspect is updated. Scaling monolithic applications efficiently may also be challenging, as it requires instances of the entire application to be deployed, even if only one aspect of the application needs to be scaled. In addition, monolithic applications are often deployed on hardware that is pre-scaled for peak loads. When a monolithic application outgrows its hardware, the hardware may have to be “scaled up” or upgraded rather than reconfiguring the datacenter and/or updating the software architecture of the application.

Even if the web, business, and data logic of a monolithic application is decomposed into separate applications to provide some level of developer agility and independent scaling, each logical tier often becomes its own separate monolithic application that integrates diverse functionality into a single software package, and thus may still suffer from challenges faced by monolithic applications.

While monolithic architectures may be suitable for certain types of applications, microservice-based architectures may be preferable for large, complex applications that require flexible development, deployment, and scaling (e.g., cloud-based applications). A microservices application, for example, may be implemented using multiple separate and self-contained applications, or microservices, that each provide a particular service and collectively form a fully functional application. A microservices architecture may allow each underlying microservice of an application to be independently developed, deployed, updated, and scaled, resulting in numerous efficiencies in the software development process.

For example, in FIG. 4B, microservices application 410B includes a variety of microservices 415 to implement the web logic, business logic, and data storage logic. For example, the web logic is implemented using various microservices 415-1 responsible for incoming connections, authentication, the user interface, and web content delivery. The business logic is implemented using various microservices 415-2 responsible for order processing, customer service, and analytics. The data storage logic is implemented using various microservices 415-3 responsible for managing storage of customer information and product inventory. In microservice-based architectures, each discrete function or service of an application is implemented by its own microservice, and each microservice is itself an independent application. Microservices are often designed to communicate using simple and well-known communication methods and protocols, such as lightweight RESTful APIs (i.e., application programming interfaces (API) implemented using representational state transfer (REST) architectures).

Microservices applications may be developed and maintained more efficiently, as complex applications are broken up into multiple smaller and more manageable applications, or microservices. The functionality of each microservice often is so focused that a particular microservice can be used for multiple different applications. Microservice-based architectures also enable the underlying microservices to be developed independently by different software development teams. Microservices can be developed using the most appropriate programming language and/or technology for each microservice, rather than being stuck with obsolete technologies or technologies that may only be suitable for certain types of microservices. The independent, distributed nature of microservice-based applications also enables them to be independently deployed and independently updated. In addition, microservice-based architectures facilitate rolling updates, where only some instances of a particular microservice are updated at any given time, allowing buggy updates to be “rolled back” or undone before all instances of the microservice are updated.

Microservice-based architectures also enable each microservice to be scaled independently, resulting in more efficient load balancing. Microservices can be scaled by deploying any number of instances of a particular microservice needed to satisfy the capacity and availability constraints of that microservice. For example, if there is a spike in incoming traffic to an application, the microservice responsible for handling incoming connections could be scaled without scaling other microservices of the application. A microservice can also be deployed on the hardware that is best-suited for its respective requirements and functionality.

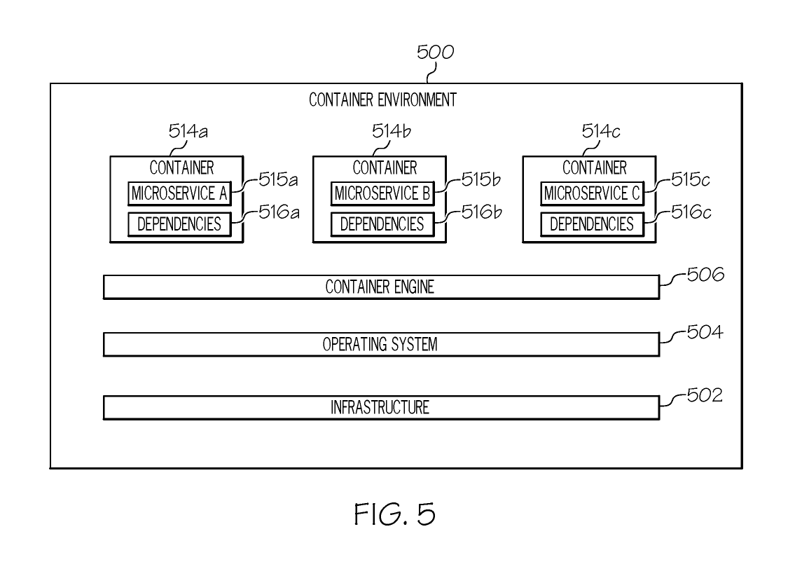

Microservices applications can be implemented using virtual machines or software containers. Software containers can be an effective complement to a microservices application, as they can be used to ensure that each microservice runs the same in any environment or infrastructure, out-of-the-box. A microservices application, for example, could be implemented using the software container environment described in connection with FIG. 5.

Microservice-based architectures are integral to various software technology advancements, including cloud-based applications and services, continuous integration and continuous deployment (CI/CD), and software container technology, among other examples.

FIG. 5 illustrates an example software container environment 500. The model generation and testing functionality described throughout this disclosure may be used to generate models for testing applications that are implemented in containerized environments, such as containerized microservices applications or application programming interfaces (APIs) used by those applications.

In some cases, for example, software applications may be implemented using software containers, such as Docker containers, containers based on the Open Container Initiative (OCI), and/or any other software container implementation. Analogous to shipping containers, software containers may package a particular software component with all of its dependencies to ensure that it runs the same in any environment or infrastructure, out-of-the-box. For example, a software container may package everything required to run a particular software component, such as the code, software libraries, APIs, configuration, files, runtime environment, and any other associated tools or applications.

Software containers enable applications to be migrated across various infrastructures and environments without any modifications or environment-specific configurations. For example, applications can be migrated to or from local workstations, development servers, test environments, and/or production environments. Software containers also enable applications to be developed using the best programming languages and tools for each application, without any internal conflicts from the requirements of different applications. Many inefficiencies of software development and deployment are eliminated with software containers, such as time spent configuring development and production environments, concerns about inconsistencies between development and production environments, and so forth. Software containers also avoid locking developers into any particular platform, software technology, and/or vendor.

Software containers running on the same machine may also share a host operating system, thus avoiding the inefficiencies of virtual machines, which each require their own guest operating system on top of the host operating system. Accordingly, in comparison to virtual machines, software containers may launch faster and use less memory.

Software components implemented using software containers may be stored as container images, which may include all components and dependencies required to run a particular software component in a software container. A container image, for example, may be a file format used to package the components and dependencies of a containerized software component. Container images may be constructed using layered filesystems that share common files, resulting in less disk storage and faster image downloads. In some cases, container images may be hosted by a software registry (e.g., software registry 170 of FIG. 1) to provide a central repository for distributing container images to software developers. Examples of container images include Docker container images, container images based on the Open Container Initiative (OCI), and/or any other container image format. The Open Container Initiative (OCI), for example, is a collaborative effort by the software industry to develop an open, vendor-neutral, and portable implementation of software containers, to ensure that compliant software containers are portable across all major operating systems and platforms that are also compliant. The OCI implementation is based on the implementation of Docker containers.

Software container environment 500 illustrates an example of a containerized implementation for a microservices application. While microservice-based architectures have many benefits, managing the microservices of an application can become challenging as the application grows and the number of microservices increases. For example, each microservice may have unique build and configuration requirements, including its own software dependencies, which may require each microservice to be custom built and/or configured, additional software to be installed, and so forth. Accordingly, software containers can be an effective complement to a microservices application, as they can be used to ensure that each microservice runs the same in any environment or infrastructure, out-of-the-box. Software containers can be used to implement microservices applications, for example, by packaging each microservice of an application into a separate software container.

In the illustrated example, container environment 500 includes infrastructure 502, operating system 504, container engine 506, and software containers 514. Infrastructure 502 includes the underlying hardware and/or software infrastructure used to provide the containerized environment, such as an application server (e.g., application server 130 of FIG. 1). Operating system 504 is operating system software executing on infrastructure 502, which can be any operating system adapted to provide a containerized environment, such as Linux, other UNIX variants, Microsoft Windows, Windows Server, Mac OS, Apple iOS, and/or Google Android, among others. Container engine 506 includes software responsible for providing and managing the containerized environment 500, such as a Docker container engine, an OCI-based container engine, and/or any other type of software container engine. Software containers 514 are containers that execute distinct software components in their own respective environments. In the illustrated example, containers 514 each include a microservice 515 and its associated dependencies 516. For example, container 514a includes microservice A (515a) and its dependencies (516a), container 514b includes microservice B (515b) and its dependencies (516b), and container 514c includes microservice C (515c) and its dependencies (516c). These microservices 515 may collectively form a microservices application that is executing on infrastructure 502 in a containerized environment 500.

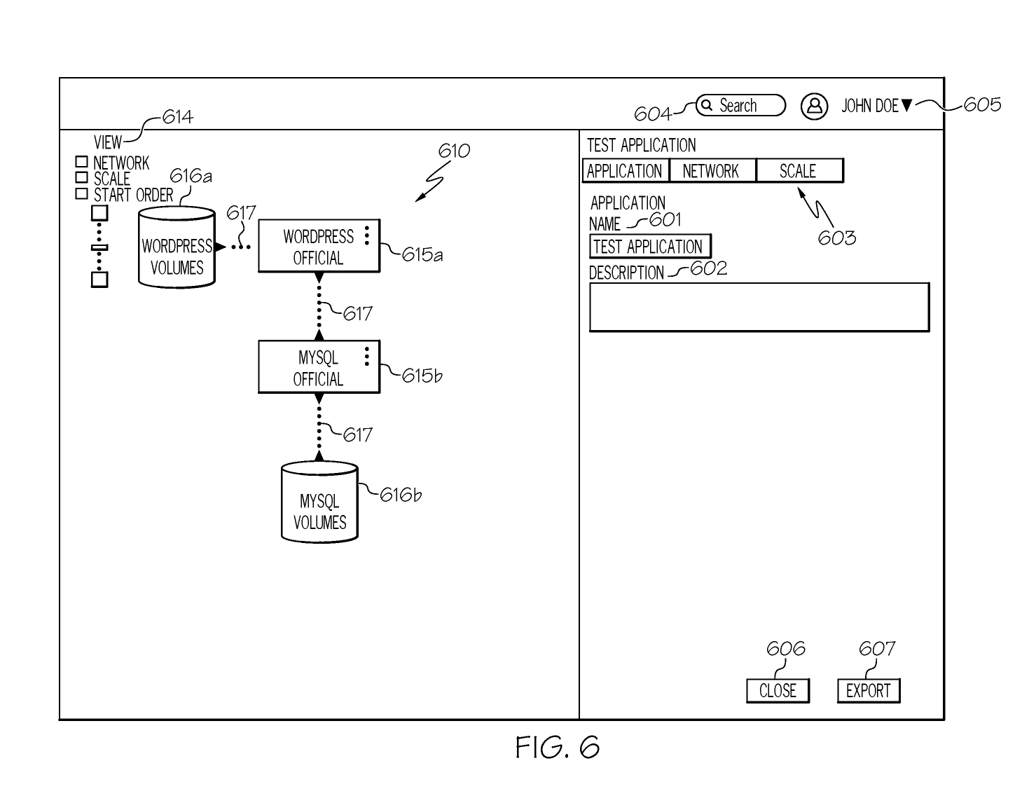

FIG. 6 illustrates an example application modeling and development tool 600. Modeling and development tool 600 may be used, for example, to provide application modeling functionality and/or other application development functionality. For example, modeling and development tool 600 may be used to model the architecture of a software application, and/or to facilitate configuration, maintenance, deployment, and/or testing of an application. In some embodiments, modeling tool 600 may include or facilitate the model generation and testing functionality described throughout this disclosure, to generate models for testing applications and application programming interfaces (APIs). In some embodiments, for example, modeling tool 600 may be used to provide the functionality described in connection with development system 220 of FIG. 2, such as the application modeler 232, testing module 235, and/or any other component of development system 220.

Modeling tool 600 may be used to design, configure, and/or update the architecture of a software application and its underlying components. Software applications may be composed of, include, and/or rely on a variety of underlying software components. For example, applications may be implemented using a variety of software design approaches (e.g., monolithic or microservices architectures), and with a variety of software modules, components, APIs, containers, services, microservices, and/or external services, among other examples. Modeling tool 600 may be used to design or configure an application, for example, by identifying each underlying component, along with its functionality and responsibilities, configuration, version, and/or relationship to other components, among other information. Modeling tool 600 may display the application's design or architecture, for example, by displaying graphical representations of each underlying software component of the application (including, for example, the name, version, and/or configuration of each component), the relationships between the underlying components, and so forth.

In some embodiments, modeling tool 600 may be a tool used for modeling and/or developing microservices applications, such as the Yipee.io tool or other microservices development tool. Microservices applications, for example, may be implemented by packaging a variety of microservices into separate software containers. In the illustrated embodiment, modeling tool 600 is used to model the architecture of a microservices application 610 and its associated microservices 615. For example, modeling tool 600 displays representations of each component of application 610, including microservices 615 and storage volumes 616, and also identifies the relationships 617 among those components. Modeling tool 600 also provides various viewing options 614 for application 610, including network, scale, and start order views. Modeling tool 600 also displays modifiable configuration fields for application 610, including the name 601 and description 602 of the application, among others. In the illustrated embodiment, the configurable fields and parameters are broken up into categories 603 (i.e., the application, network, and scale categories 603). Modeling tool 600 also provides search functionality 604, identifies the current user or developer 605, and includes buttons for closing 606 and/or exporting 607 the configuration of an application 610.

In some embodiments, modeling and development tool 600 may also provide other microservices development functionality, including configuration, maintenance, deployment, and/or testing of microservices applications. For example, modeling and development tool 600 may be used to configure the orchestration environment for a microservices application, such as an orchestration environment provided by Kubernetes, Docker Swarm, and/or Apache Mesos, among other orchestration tools. Orchestration tools, for example, may be used to facilitate and/or automate deployment, scaling, and/or operation of containerized applications.

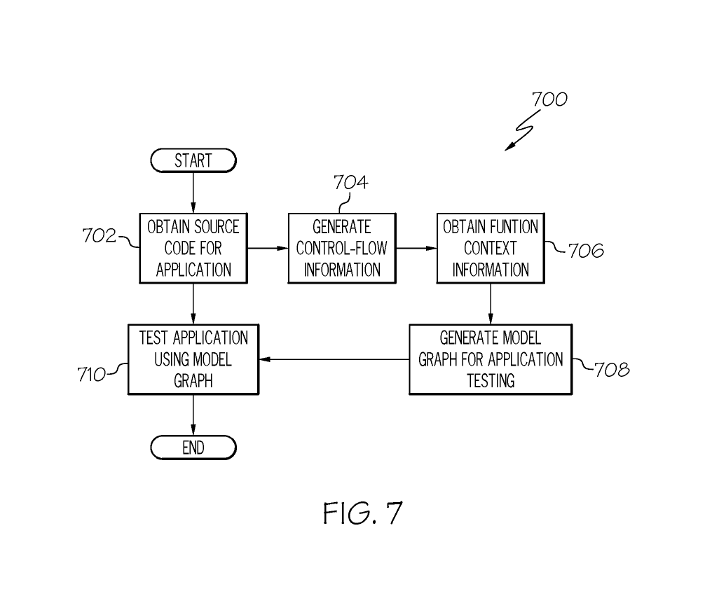

FIG. 7 illustrates a flowchart 700 for an example embodiment of model generation for model-based application testing. Flowchart 700 may be implemented, in some embodiments, by components described throughout this disclosure (e.g., development system 120 of FIG. 1 and/or development system 220 of FIG. 2).

The flowchart may begin at block 702 by obtaining source code for an application, along with other associated files and information. For example, for a Java-based API, the Java archive file (JAR) and the source code of the API may be obtained.

The flowchart may then proceed to block 704 to generate control-flow information indicating an approximate function execution order for the application. For example, a JAR file may be used to extract all the classes and functions of a Java API. In addition, the source code may be parsed using program splicing techniques to identify the code flow and the atomicity of the variables, and derive an approximate order of function execution. This may facilitate an understanding of the call flow for the application, including the starting points and control flows for the application's data.

The flowchart may then proceed to block 706 to obtain function context information for the application. The function context information, for example, may provide information relating to the execution context of one or more functions of the application. For example, the function context information may identify the parent functions, function input criteria, and function validation criteria for the functions of the application. In some embodiments, annotations may be used to specify the function context information for each function. For example, in some embodiments, the annotations may be specified using a metalanguage, such as the metalanguage illustrated in FIGS. 3B and 3C.

In some embodiments, the function context information may be derived from code parsing and machine learning, but certain function context information may also be provided by a user or developer. Machine learning techniques may be used, for example, to derive and/or further refine the control-flow information and function context information (e.g., by analyzing existing or previously provided test cases, test models, code flow analysis, and/or user annotations of control-flow and function context information). In some embodiments, the control-flow information and function context information may be combined to form a partial model of the application.

The flowchart may then proceed to block 708 to generate a model graph for testing the application. For example, at this point, the control-flow information and function context information (i.e., the partial model) may contain sufficient information for creating a model graph of the application. For example, the partial model may identify the classes and functions of the API or application, along with the function control flow, parent functions, function input criteria, and/or function validation criteria. Accordingly, a model graph for the application may then be generated using the partial model. For example, the model graph may include nodes representing each function, with edges between nodes to represent the control-flow of the functions. The model graph may also identify the input criteria and validation criteria for each function.

The flowchart may then proceed to block 710 to test the application using the model graph. For example, the model graph may enable model-based testing of the application, which may involve automated testing of the application using test cases generated from the model graph. For example, the model graph may be used to generate inputs to the functions (e.g., based on the function input criteria), execute the functions using the generated inputs and according to the identified control-flow, and determine whether the output of each function is valid (e.g., using the output validation criteria).

At this point, the flowchart may be complete. In some embodiments, however, the flowchart may restart and/or certain blocks may be repeated. For example, in some embodiments, the flowchart may restart at block 702 to continue generating models and testing applications.

The flowcharts and block diagrams in the FIGURES illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method comprising:
generating, using source code for an application, control-flow information comprising an indication of function execution order for the application;
identifying function information for the application, the function information comprising an indication of an execution context for a function of the application; and
generating, based on the control-flow information and the function information, a model graph to test the application.

2. The method of claim 1, further comprising testing the application using the model graph.

3. The method of claim 2, wherein testing the application using the model graph comprises:
generating, based on the model graph, an input to the function;
executing the function using the generated input; and
determining, based on the model graph, whether an output of the function is valid.

4. The method of claim 1, wherein the control-flow information is generated by parsing the source code using a program slicing technique.

5. The method of claim 1, wherein the function information comprises an identification of a parent function of the function.

6. The method of claim 1, wherein the function information comprises function validation information, the function validation information comprising an identification of valid output of the function.

7. The method of claim 1, wherein the function information comprises function input information, the function input information comprising an identification of valid input to the function.

8. The method of claim 1, wherein the function information is obtained from a user.

9. The method of claim 8, further comprising generating additional function information based on an evaluation of the function information obtained from the user.

10. The method of claim 1, wherein the function information is identified based on an evaluation of a test case for the application.

11. The method of claim 1, wherein the function information is identified by parsing the source code for the application.

12. The method of claim 1, wherein the function information is represented using a metalanguage.

13. A system comprising:
a processor device;
a memory element; and
an application testing agent stored in the memory element, the application testing agent comprising one or more instructions executable by the processor device, the one or more instructions configured to:
generate, using source code for an application, control-flow information comprising an indication of function execution order for the application;
identify function information for the application, the function information comprising an indication of an execution context for a function of the application;
generate, based on the control-flow information and the function information, a model graph to test the application; and
test the application using the model graph.

14. The system of claim 13, wherein the one or more instructions configured to test the application using the model graph are further configured to:
generate, based on the model graph, an input to the function;
execute the function using the generated input; and
determine, based on the model graph, whether an output of the function is valid.

15. The system of claim 13, wherein the one or more instructions are further configured to generate the control-flow information by parsing the source code using a program slicing technique.

16. The system of claim 13, wherein the one or more instructions are further configured to obtain the function information from a user.

17. The system of claim 16, wherein the one or more instructions are further configured to generate additional function information based on an evaluation of the function information obtained from the user.

18. The system of claim 13, wherein the one or more instructions are further configured to identify the function information based on an evaluation of a test case for the application.

19. The system of claim 13, wherein the one or more instructions are further configured to identify the function information by parsing the source code for the application.

20. A non-transitory computer readable medium having program instructions stored thereon that are executable to cause a computer system to perform operations comprising:
generating, using source code for an application, control-flow information comprising an indication of function execution order for the application;
identifying function information for the application, the function information comprising an indication of an execution context for a function of the application; and
generating, based on the control-flow information and the function information, a model graph to test the application.
